(19) United States
(12) Patent Application Publication
(10) Pub. No.: US 2010/0156777 A1
(43) Pub. Date: Jun. 24, 2010

(54) METHOD OF DRIVING LIGHT SOURCE, LIGHT SOURCE APPARATUS FOR PERFORMING THE METHOD AND DISPLAY APPARATUS HAVING THE LIGHT SOURCE APPARATUS

(75) Inventors: Hyung-Ku Kang, Seoul (KR); Hyeon-Yong Jang, Osan-si (KR); Hyuk-Hwan Kim, Asan-si (KR); Dae-Gwang Jang, Incheon (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/482,889

(22) Filed: Jun. 11, 2009

(30) Foreign Application Priority Data
Dec. 19, 2008 (KR) 2008-129995

(51) Int. Cl. G09G 3/36

(52) U.S. Cl. 345/102

(57) ABSTRACT

A method of driving a light source includes; driving a plurality of light-emitting blocks included in a light source module at a uniform luminance during an initial period in response to a power-on signal, and subsequently driving the plurality of light-emitting blocks individually in accordance with respective luminances of a plurality of image blocks aligned with each of the plurality of light-emitting blocks after the initial period.

This application claims priority to Korean Patent Application No. 2008-129995, filed on Dec. 19, 2008, and all the benefits accruing therefrom under 35 U.S.C. §119, the contents of which in its entirety are herein incorporated by reference.

### BACKGROUND OF THE INVENTION

1. Field of the Invention

Exemplary embodiments of the present invention relate to a method of driving a light source, a light source apparatus for performing the method and a display apparatus having the light source apparatus. More particularly, exemplary embodiments of the present invention relate to a method of driving a light source capable of improving display quality, a light source apparatus for performing the method and a display apparatus having the light source apparatus.

2. Description of the Related Art

Generally, a liquid crystal display (“LCD”) device includes an LCD panel displaying an image using the transmissivity of liquid crystal and a backlight assembly disposed behind of the LCD panel, from the perspective of a viewer, to provide the LCD panel with light.

The LCD panel typically includes an array substrate, a color filter substrate and a liquid crystal layer. The array substrate typically includes a plurality of pixel electrodes and a plurality of thin-film transistors (“TFTs”) each of which is connected to an individual pixel electrode of the plurality of pixel electrodes, respectively. The color filter substrate typically includes a common electrode and a plurality of color filters. The liquid crystal layer is typically interposed between the array substrate and the color filter substrate. The arrangement of the liquid crystal layer is altered by an electric field formed between the pixel electrode and the common electrode, and thus the transmittance ratio of light transmitted through the liquid crystal layer may be varied according to the arrangement of liquid crystal molecules in the liquid crystal layer. The LCD panel may display a white image having a high luminance when the light transmittance ratio is increased to maximum and the LCD panel may display a black image having a low luminance when the light transmittance ratio is decreased to minimum.

Recently, a dimming technology has been developed for the LCD device, which decreases an amount of light emitted from a backlight module and increases a light transmittance of a pixel of the LCD panel. The dimming technology of the backlight module has been developed in conjunction with a light-emitting module having a light-emitting diode (“LED”) and the dimming technology has been employed in a lamp module having a lamp.

In the displays utilizing a lamp module, one-dimensional dimming technology may be implemented due to linear characteristics of a lamp. The one-dimensional dimming technology may include dividing a light source into linear light-emitting blocks according to a driving of the lamp, and may obtain luminance data by analyzing image data of image areas respectively corresponding to the light-emitting blocks. Each of the light-emitting blocks is driven by a driving signal generated using the obtained luminance data. The LCD panel compensates pixel data using the luminance data.

However, according to the driving characteristics of the lamp, the lamp may not display a rapidly changing high luminance image at a required luminance because the lamp is cooled to a low temperature when the lamp is driven at a low luminance for a long time, and thus may not rapidly return to the proper higher temperature for high luminance display. On the contrary, the lamp may not display a rapidly changing low luminance image at a required luminance because the lamp is heated to a high temperature when the lamp is driven at a high luminance for a long time, and thus may not rapidly return to the proper lower temperature for low luminance display. Therefore, a problem such as non-uniform luminance on a screen may occur.

### BRIEF SUMMARY OF THE INVENTION

Exemplary embodiments of the present invention provide a method of driving a light source capable of improving luminance characteristics in accordance with a driving temperature of the light source.

Exemplary embodiments of the present invention also provide a light source apparatus for performing the above-mentioned method.

Exemplary embodiments of the present invention also provide a display apparatus having the above-mentioned light source apparatus.

In one exemplary embodiment of the present invention, a method of driving a light source includes; driving a plurality of light-emitting blocks included in a light source module at a substantially uniform luminance during an initial period in response to a power-on signal, and subsequently driving the plurality of light-emitting blocks individually in accordance with respective luminances of a plurality of image blocks aligned with each of the plurality of light-emitting blocks after the initial period. In one exemplary embodiment, the substantially uniform luminance may be a maximum luminance of the plurality of light-emitting blocks.

According to another exemplary embodiment of the present invention, a light source apparatus includes; a light source module including a plurality of light-emitting blocks, a driving signal generating part which drives the plurality of light-emitting blocks to a substantially uniform luminance during an initial period in response to a power-on signal, and a local dimming control part which individually controls a luminance of the plurality of light-emitting blocks in accordance with respective luminances of a plurality of image blocks aligned with each of the plurality of light-emitting blocks after the initial period.

According to still another exemplary embodiment of the present invention, a display apparatus includes a display panel, a light source module including a plurality of light-emitting blocks, a driving signal generating part which drives the plurality of light-emitting blocks to a substantially uniform luminance during an initial period in response to a power-on signal, a local dimming control part which individually controls a luminance of each of the plurality of light-emitting blocks in accordance with respective luminances of a plurality of image blocks aligned with each of the plurality of light-emitting blocks after the initial period, a compensation part which compensates pixel data of the plurality of image blocks in correspondence to the luminance of the plurality of light-emitting blocks, and a panel driving part which drives the display panel.

According to the present invention, when a driving of a light source is started by a power-on signal, a plurality of light sources is driven at a substantially uniform luminance employed in the light source apparatus during an initial period from a driving start time of the light source, so that driving temperatures of the light sources are uniform so that a luminance deviation according to the driving temperatures may be prevented.

### BRIEF DESCRIPTION OF THE DRAWINGS

The above and other aspects, features and advantages of the present invention will become more apparent by describing in further detail exemplary embodiments thereof with reference to the accompanying drawings, in which:

FIG. 1 is a block diagram illustrating an exemplary embodiment of a display apparatus according to the present invention;

FIG. 2 is a graph illustrating exemplary embodiments of the driving characteristics of the light source of FIG. 1;

FIGS. 3A to 3C are flowcharts illustrating an exemplary embodiment of a method of driving the exemplary embodiment of a display apparatus of FIG. 1; and

FIG. 4 is a waveform diagram illustrating an exemplary embodiment of a driving signal according to the exemplary embodiment of a light source apparatus of FIG. 1.

### DETAILED DESCRIPTION OF THE INVENTION

The present invention now will be described more fully hereinafter with reference to the accompanying drawings, in which exemplary embodiments of the present invention are shown. The present invention may, however, be embodied in many different forms and should not be construed as limited to the example embodiments set forth herein. Rather, these exemplary embodiments are provided so that this disclosure will be thorough and complete, and will fully convey the scope of the present invention to those skilled in the art. Like reference numerals refer to like elements throughout. In the drawings, the sizes and relative sizes of layers and regions may be exaggerated for clarity.

It will be understood that when an element or layer is referred to as being “on” another element, it can be directly on the other element or intervening elements may be present. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the present invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the present invention will be explained in detail with reference to the accompanying drawings.

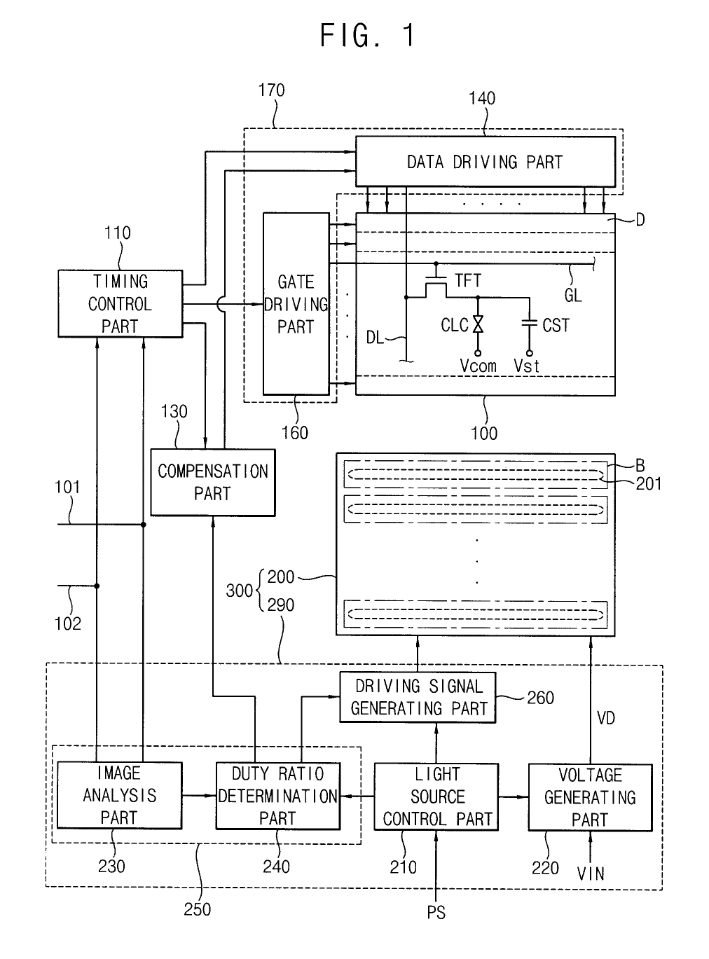

FIG. 1 is a block diagram illustrating an exemplary embodiment of a display apparatus according to the present invention.

Referring to FIG. 1, the display apparatus includes a display panel 100, a timing control part 110, a compensation part 130, a panel driving part 170 and a light source apparatus 300.

In the present exemplary embodiment, the display panel 100 includes M data lines (wherein M is a natural number), N gate lines (wherein N is a natural number) and m×n pixels (wherein m and n are natural numbers). Each of the pixels includes a switching element TFT connected to an individual gate line GL and an individual data line DL, a liquid crystal capacitor CLC and a storage capacitor CST connected to the switching element TR. Exemplary embodiments include configurations wherein the storage capacitor CST may be omitted.

The timing control part 110 receives a control signal 101 and pixel data 102 from an external device (not shown). The timing control part 110 generates a timing control signal for controlling driving timing of the display panel 100 using the received control signal 101. Exemplary embodiments of the control signal 101 may include a clock signal, a horizontal start signal, a vertical start signal, and other similar signals.

The compensation part 130 compensates pixel data, exemplary embodiments of which may include image data, using duty ratio data provided from the light source apparatus 300, and provides the compensated pixel data to a data driving part 140.

The panel driving part 170 includes the data driving part 140 and a gate driving part 160. The data driving part 140 converts the pixel data into an analogue data voltage, based on the timing control signal. The data driving part 140 outputs the analogue data voltage to the data line DL of the display panel 100. The gate driving part 160 generates a gate signal based on the timing control signal, and outputs the gate signal to the gate line GL of the display panel 100.

The light source apparatus 300 supplies light to the display panel 100. The light source apparatus 300 includes a light source module 200 and a light source driving part 290. In the present exemplary embodiment, the light source module 200 includes a plurality of light sources 201. The light source module 200 may be divided into a plurality of light-emitting blocks B. Each of the light-emitting blocks B includes at least one light source. Exemplary embodiments include configurations wherein the light-emitting blocks B may be individually driven.

A one-dimensional dimming method or two-dimensional dimming method may be employed in the light source module 200 in accordance with the shape of the light source. In an exemplary embodiment wherein the light source is a fluorescent lamp, the one-dimensional dimming method performing local dimming in one direction may be applied to the light source module 200. Generally, in an exemplary embodiment in which lamps are used, each of the lamps may not emit light having substantially the same luminance with each other even though the same driving signal is applied to the lamps, specifically when the temperatures of the lamps are not uniform. One particular instance where the temperature is non-uniform is when the temperatures have not been increased by driving the lamps for a predetermined time. The lamp may not emit light having a required luminance because the lamp is cooled to a lower temperature when the lamp is driven at a low luminance for a long time. In an exemplary embodiment in which the one-dimensional dimming method is applied to the lamp, the lamp does not always turn on, and the temperature of the respective lamps in the light-emitting blocks B is different from one another according to a driving time of the lamp and the level of a driving signal for driving the lamp. Therefore, each of the lamps may have a different luminance from one another due to respective temperatures of the lamps in the light-emitting blocks B, although the same driving signal is applied to the light-emitting blocks B.

When a power-on signal is applied to the light source driving part 290, the light source driving part 290 supplies substantially the same driving signal to the light-emitting blocks B during an initial period and equalizes the respective temperatures of the lamps so as to eliminate a luminance difference between the lamps. In one exemplary embodiment, the same driving signal may be a signal having a maximum level among signals driving the light-emitting blocks B. The same driving signal may be a driving signal corresponding to a warm-up luminosity of the lamps, which in one exemplary embodiment may be a maximum luminosity In one exemplary embodiment, the warm-up luminosity may be a luminosity which sufficiently heats the light sources so that a difference between a luminance according to a duty ratio of a driving signal and a target luminance is less than about 80% during a period after the initial period as will be described in more detail below. In one exemplary embodiment, the level of the driving signal may be a duty ratio level or a peak current level.

The light source driving part 290 includes a light source control part 210, a voltage generating part 220, a local dimming control part 250 and a driving signal generating part 260.

The light source control part 210 controls a driving of the light source apparatus 300 based on a power control signal PS received from an external source. In one exemplary embodiment, when the light source control part 210 receives a power-on signal POWER-ON as the power control signal PS, the light source control part 210 controls the light source apparatus 300 so that the light source apparatus 300 drives the light-emitting blocks B to a substantially uniform luminance during the initial period and the light source control part 210 controls the light source apparatus 300 so that the light source apparatus 300 drives the light-emitting blocks B by a local dimming method after the initial period.

The uniform luminance may be a maximum luminance. A stabilization time in a case in which the light-emitting blocks B are driven at the uniform luminance may be longer than a stabilization time in a case in which the light-emitting blocks B are driven at the maximum luminance. Therefore, it is preferable driving the light-emitting blocks B at the maximum luminance during the initial period because driving the light-emitting blocks B at the maximum luminance may decrease the stabilization time.

The voltage generating part 220 generates a driving voltage driving the light source apparatus 300 using an input voltage VIN. In one exemplary embodiment, the driving voltage may include a light source voltage VD driving the light source module 200.

The local dimming control part 250 individually controls a luminance of the respective light-emitting blocks B according to respective luminances of a plurality of image blocks corresponding to the light-emitting blocks B, after the initial period. In one exemplary embodiment, the local dimming control part 250 individually controls a luminance of the respective light-emitting blocks B according to respective luminances of a plurality of image blocks aligned with the light-emitting blocks B, after the initial period. In the present exemplary embodiment, the local dimming control part 250 includes an image analysis part 230 and a duty ratio determination part 240.

The image analysis part 230 divides a frame image into a plurality of image blocks D corresponding to the light-emitting blocks B using the control signal 101 and the pixel data 102. In one exemplary embodiment, the image analysis part 230 divides a frame image into a plurality of image blocks D aligned with the light-emitting blocks B using the control signal 101 and the pixel data 102. The image analysis part 230 obtains representative luminance data of the light-emitting blocks B using pixel data of the respective image blocks D. Exemplary embodiments of a method of obtaining the representative luminance data of the light-emitting blocks B includes an average value obtaining method, a maximum value obtaining method and other similar methods. According to an exemplary embodiment of the average value obtaining method, an average value of the pixel data in the image blocks D is obtained as the representative luminance data, and according to an exemplary embodiment of the maximum value obtaining method, a maximum value of the pixel data in the image blocks D is obtained as the representative luminance data.

The duty ratio determination part 240 determines duty ratio data of a driving signal driving the light source using the representative luminance data of the light-emitting blocks B provided from the image analysis part 230.

In one exemplary embodiment, the driving signal may be a pulse width modulation (“PWM”) signal, and a percent range of the duty ratio data may be about 10% to about 50%. Therefore, in one exemplary embodiment, the light-emitting blocks B may be driven with about 50% duty ratio data so that the light-emitting blocks B are driven at the maximum luminance, during the initial period. The range of the duty ratio data may be variably changed according to design details of the light source apparatus 300 such as the driving characteristics of the light source, an optical sheet details and so on. In one exemplary embodiment, the maximum duty ratio may comply with a 500 nit luminance condition for televisions.

The duty ratio determination part 240 provides the determined duty ratio data of the light-emitting blocks B to the compensation part 130. The compensation part 130 compensates the pixel data of the image blocks D using the duty ratio data. In one exemplary embodiment, the compensation part 130 does not compensate the pixel data during the initial period. That is, during the initial period the display panel 100 displays an image corresponding to original pixel data which is irrelevant to the luminance of the light-emitting blocks B which are forcibly driven at a high luminance.

The driving signal generating part 260 generates the pulse width modulated driving signal and provides the driving signal to the light-emitting blocks B. In one exemplary embodiment, the driving signal generating part 260 may generate driving signals for driving the light-emitting blocks B to the maximum luminance during the initial period, in response to the power-on signal. In one exemplary embodiment, the driving signal generating part 260 may generate driving signals having the maximum duty ratio and provide the driving signals to the light-emitting blocks B during the initial period. In such an exemplary embodiment, after the initial period the driving signal generating part 260 generates a driving signal corresponding to the duty ratio data provided from the duty ratio determination part 240 to drive the light-emitting blocks B by the local dimming method.

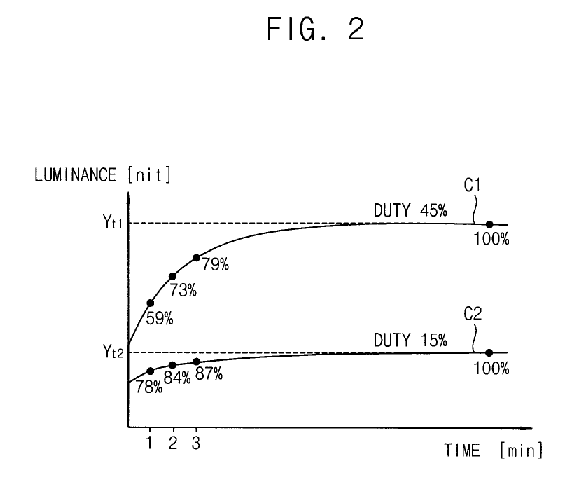

FIG. 2 is a graph illustrating exemplary embodiments of the driving characteristics of the light source apparatus 300 of FIG. 1.

Referring to FIGS. 1 and 2, a first curve C1 is a luminance curve of a first light-emitting block and a second curve C2 is a luminance curve of a second light-emitting block. A first driving signal having a duty ratio of about 45% is applied to a first light source included in the first emitting block and a second driving signal having a duty ratio of about 15% is applied to a second light source included in the second emitting block.

When the first and second light sources are turned on in a completely cooled state as shown, at an initial one minute lapse point, the first curve C1 of the first light-emitting block reached about 59% in comparison with a first target luminance Yₜ₁ corresponding to the first driving signal, the second curve C2 of the second light-emitting block reached about 78% in comparison with a second target luminance Yₜ₂ corresponding to the second driving signal. At an initial two minute lapse point, the first curve C1 of the first light-emitting block reached about 73% in comparison with the first target luminance Yₜ₁, the second curve C2 of the second light-emitting block reached about 84% in comparison with the second target luminance Yₜ₂. At an initial three minute lapse point, the first curve C1 of the first light-emitting block reached about 79% in comparison with the first target luminance Yₜ₁, the second curve C2 of the second light-emitting block reached about 87% in comparison with the second target luminance Yₜ₂.

After the first and second light-emitting blocks start driving, a difference of luminance shortages in comparison between actual luminances and first and second target luminances Yₜ₁ and Yₜ₂ is relatively great until the two minute lapse point, e.g., 27% and 16%, respectively. Therefore, a luminance difference of the first and second light-emitting blocks may be generated in a screen during the initial two minutes when the light-emitting blocks B are driven by dimming driving.

At the three minute lapse point after the first and second light-emitting blocks start driving, the first and second curve C1 and C2 of the first and second light-emitting block reached about 80% of their target luminances, and thus the difference of luminance shortages in comparison between actual luminances and first and second target luminances Yₜ₁ and Yₜ₂ is relatively less than the difference of luminance shortages at the one minute lapse point and two minute lapse point.

After the three minute lapse point, the first curve C1 of the first light-emitting block exponentially stabilizes to the first target luminance Yₜ₁ corresponding to a duty ratio of about 45%, the second curve C2 of the second light-emitting block stabilizes to the second target luminance Yₜ₂ corresponding to a duty ratio of about 15%.

However, in a case in which a driving signal having a high duty ratio greater than about 45% is suddenly applied to the first and second light-emitting blocks stabilized to the about 45% and about 15%, heating and a luminance stabilization process may be required so as to drive the first and second light-emitting blocks to a high luminance corresponding to the duty ratio.

Hereinafter, an exemplary embodiment of a driving method for eliminating a luminance difference according to the driving characteristic described with reference to FIG. 2 will be described.

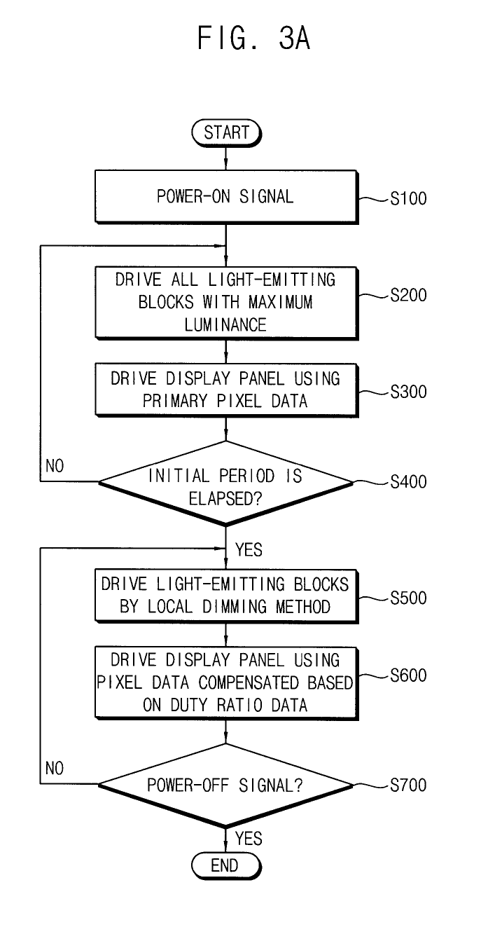

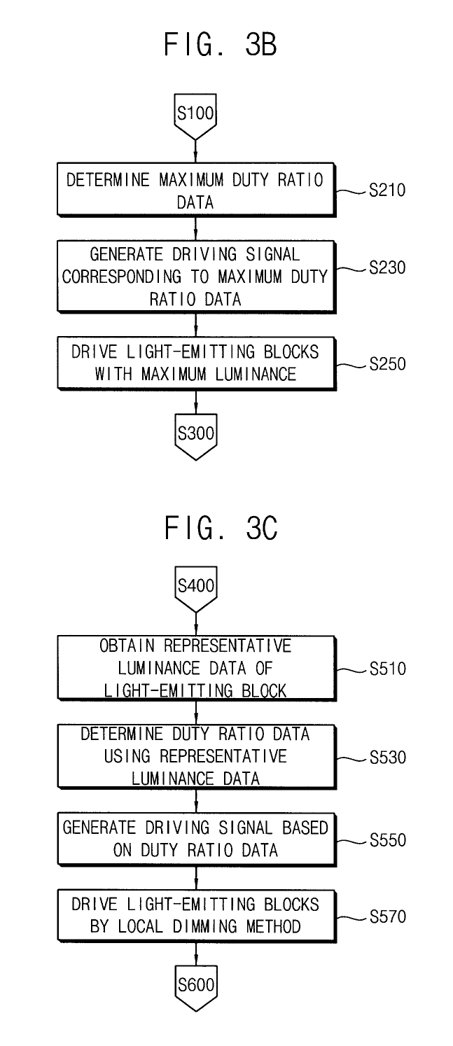

FIGS. 3A to 3C are flowcharts illustrating an exemplary embodiment of a method of driving the exemplary embodiment of a display apparatus of FIG. 1.

Referring to FIGS. 1 and 3A, a method of driving the display apparatus is divided into an initial driving method and a local dimming method. The initial driving method is described as follows.

The power-on signal is applied to the display apparatus as the power control signal (STEP S100). The light source control part 210 drives the light-emitting blocks B to the maximum luminance, in response to the power-on signal (STEP S200). In one exemplary embodiment, the power-on signal may be applied to the light source apparatus 300 through a user interface such as a power button or a remote control.

An exemplary embodiment of STEP S200 in FIG. 3A may include steps illustrated in FIG. 3B. After the light source control part 210 receives the power-on signal as the power control signal, the light source control part 210 controls the duty ratio determination part 240. The duty ratio determination part 240 determines a duty ratio of the light-emitting blocks B forming the light source module 200 as maximum duty ratio data corresponding to a maximum duty ratio (STEP S210). The driving signal generating part 260 generates a driving signal to drive the light-emitting blocks B using the maximum duty ratio data (STEP S230). In this exemplary embodiment, the duty ratio determination part 240 determines the maximum duty ratio data during the initial period and the driving signal generating part 260 generates the driving signals having the maximum duty ratio using the maximum duty ratio data. However, alternative exemplary embodiments also include configurations wherein the driving signal generating part 260 may directly generate the driving signals having the maximum duty ratio during the initial period, in response to the power-on signal.

The driving signal generating part 260 outputs the driving signal having the maximum duty ratio to the light-emitting blocks B. Therefore, the light-emitting blocks B forming the light source module 200 are driven at a maximum luminance (STEP S250). In this exemplary embodiment, the light-emitting blocks B are driven at the maximum luminance using the driving signal having the maximum duty ratio; however, alternative exemplary embodiments also include configurations wherein the light-emitting blocks B may be driven at the maximum luminance by maximizing a peak current of the driving signal.

The display panel 100 displays an image based on a primary pixel data during the initial period (STEP S300). In one exemplary embodiment, the duty ratio determination part 240 may not provide the determined maximum duty ratio data to the compensation part 130 during the initial period. The compensation part 130 may not compensate the pixel data during this period and may therefore provide the primary pixel data to the data driving part 140 which is irrelevant to the maximum duty ratio data during the initial period although the duty ratio determination part 240 provides the maximum duty ratio data to the compensation part 130. In the exemplary embodiment of a method described above, the compensation part 130 does not compensate the pixel data during the initial period.

The data driving part 140 converts the primary pixel data into an analogue data signal and outputs the converted primary pixel data to the data line DL. The gate driving part 160 outputs a gate signal to the gate line GL of the display panel 100, in synchronization with the data signal outputted from the data driving part 140.

Therefore, the display panel 100 displays a primary image and the light-emitting blocks are driven at the maximum luminance, during the initial period.

Then, it is checked whether or the initial period has elapsed (STEP S400). When the result of the checking is that the initial period has not elapsed in STEP S400, the process returns to STEP S200. When the result of the checking is that the initial period has elapsed in STEP S400, the light-emitting blocks B are driven by the local dimming method, based on pixel data (STEP S500).

An exemplary embodiment of STEP S500 in FIG. 3A may include steps illustrated in FIG. 3C. In one exemplary embodiment, the image analysis part 230 divides the pixel data to the image blocks D corresponding to, or in one exemplary embodiment aligned with, the light-emitting blocks B and obtains representative luminance data of the light-emitting blocks B using the pixel data of the respective image block D (STEP S510). The duty ratio determination part 240 determines duty ratio data controlling a luminance of the light-emitting blocks B using the representative luminance data (STEP S530). The driving signal generating part 260 generates a driving signal having a duty ratio corresponding to the duty ratio data (STEP S550). The driving signal generating part 260 outputs the driving signal corresponding to the duty ratio data to the light-emitting blocks B to drive the light-emitting blocks B (STEP S570). As a result, the light-emitting blocks B forming the light source module 200 are driven by the local dimming method, according to the luminance of the image blocks D.

In one exemplary embodiment, the display panel 100 displays an image according to a compensated pixel data based on the duty ratio data determined by the duty ratio determination part 240, during a time period wherein the light source module 200 is driven by the local dimming method (STEP S600).

The compensation part 130 compensates pixel data of the image block D corresponding to the duty ratio data. In one exemplary embodiment, the compensation part 130 may lower a grayscale of the pixel data when the duty ratio data of the light-emitting block B is a low duty ratio data and raise the grayscale of the pixel data when the duty ratio data of the light-emitting block B is a high duty ratio data to increase a darkness contrast ratio. The data driving part 140 converts the pixel data received from the compensation part 130 into an analog data signal. The data driving part 140 outputs the data signal to the data line DL of the display panel 100. The gate driving part 160 outputs a gate signal to the gate line GL of the display panel 100, in synchronization with the data signal outputted from the data driving part 140.

Therefore, during the local dimming period, the display panel 100 displays a compensated image corresponding to the light-emitting blocks B and the light-emitting blocks B are driven by the local dimming method.

When a power-off signal is applied to the light source apparatus 300 during the local dimming driving period (STEP S700), the light source module 200 is turned off and the display panel 100 is turned off. Exemplary embodiments of the power-off signal may be a signal applied by a user through a user interface or a protection signal generated according to an additional protection function for protecting the light source apparatus 300 from heat.

After the light source apparatus 300 is stopped and turned off, the light source apparatus 300 performs the initial driving when the light source apparatus 300 is turned on again by the power-on signal.

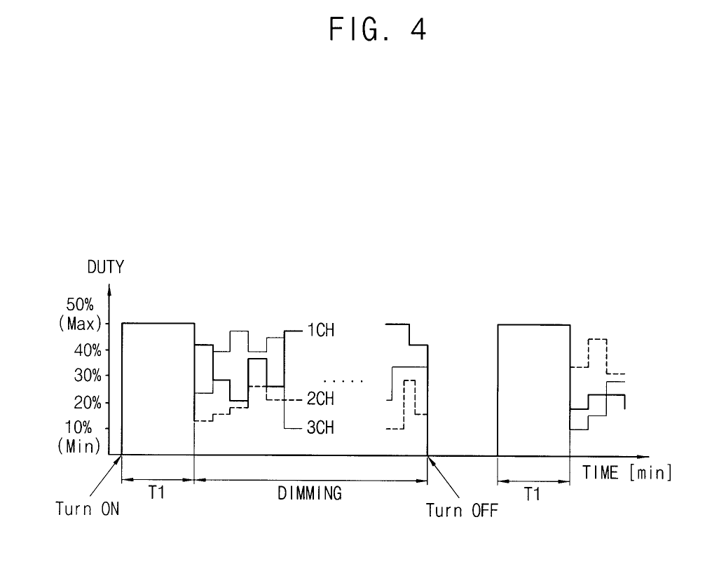

FIG. 4 is a waveform diagram illustrating an exemplary embodiment of a driving signal according to the light source apparatus of FIG. 1.

Referring to FIG. 1 and FIG. 4, an exemplary embodiment of the light source module 200 includes a first light-emitting block, a second light-emitting block and a third light-emitting block. In the present exemplary embodiment, a first driving signal 1CH, a second driving signal 2CH and a third driving signal 3CH are applied to the first, second and third light-emitting blocks, respectively.

When a power-on signal is applied to the light source apparatus 300, the first, second and third driving signals 1CH, 2CH and 3CH having a uniform duty ratio for driving at a substantially uniform luminance are applied to the first, second and third light-emitting blocks, during an initial period T1. Hereinafter, in a case in which the uniform luminance is a maximum luminance is described as an example.

When the power-on signal is applied to the light source apparatus 300, the first, second and third driving signals 1CH, 2CH and 3CH corresponding to about 50%, which in the present exemplary embodiment is a maximum duty ratio, are applied to the first, second and third light-emitting blocks, during an initial period T1. In this exemplary embodiment, a range of the duty ratio is about 10% to about 50%. Therefore, the light-emitting module 200 including the first, second and third light-emitting blocks generates light of a maximum luminance. After the initial period T1, the first, second and third driving signals 1CH, 2CH and 3CH having a duty ratio corresponding to a respective luminances of a plurality of image blocks are applied to the first, second and third light-emitting blocks. The light-emitting module 200 is driven by the local dimming method after the initial period T1.

When the power-off signal is applied to the light source apparatus 300, the first, second and third driving signals 1CH, 2CH and 3CH for lighting the first, second and third light-emitting blocks are not applied to the first, second and third light-emitting blocks, e.g., the driving signals are stopped.

After a predetermined time, when the power-on signal is applied to the light source apparatus 300 again, the first, second and third driving signals 1CH, 2CH and 3CH corresponding to about 50% that is the maximum duty ratio are applied to the first, second and third light-emitting blocks, during the initial period T1. Therefore, respective temperatures of the first, second and third light-emitting blocks are substantially equal with one another, and thus a luminance difference by the local dimming driving may be prevented. Exemplary embodiments of the predetermined time may be established based on a cooling rate of the light sources in the light emitting blocks.

In an exemplary embodiment in which the light sources are driven by the local dimming method after heating the light sources to an increased temperature by driving the light sources with a maximum duty ratio during an initial period, a difference between a luminance according a duty ratio of a driving signal and a target luminance may be decreased. Therefore exemplary embodiments, during the initial period, include driving of the light sources with a maximum duty ratio applied to the light source apparatus. Exemplary embodiments also include configurations wherein the maximum duty ratio applied to the light source may be variably set, and thus during the initial period, the light sources may be driven by the variable maximum duty ratio. Exemplary embodiments include configurations wherein the light sources are driven with a substantially similar duty ratio during the initial period, and that substantially similar duty ratio may be any duty ratio which sufficiently heats the light sources so that a difference between a luminance according to a duty ratio of a driving signal and a target luminance is less than about 80% during a period after the initial period.

According to the present invention, the generation of a luminance difference according to respective driving temperatures of the light sources may be prevented although the light sources are driven by a local dimming driving, by equalizing driving temperatures of the light sources and driving the light sources to a substantially uniform luminance applied to the light source apparatus during an initial period after a driving of a light source device starts by a power-on signal.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A method of driving a light source, the method comprising:
driving a plurality of light-emitting blocks included in a light source module at a substantially uniform luminance during an initial period in response to a power-on signal; and
subsequently driving the plurality of light-emitting blocks individually in accordance with respective luminances of a plurality of image blocks aligned with each of the plurality of light-emitting blocks after the initial period.

2. The method of claim 1, wherein the substantially uniform luminance corresponds to a maximum luminance of the light-emitting blocks.

3. The method of claim 2, wherein each of the plurality of light-emitting blocks comprises at least one lamp.

4. The method of claim 3, wherein driving the plurality of light-emitting blocks at the substantially uniform luminance comprises:
generating a driving signal having a uniform duty ratio corresponding to the substantially uniform luminance during the initial period.

5. The method of claim 3, wherein driving the plurality of light-emitting blocks individually comprises:
determining a duty ratio data of the respective light-emitting blocks using pixel data included in the respective image blocks;
generating a driving signal corresponding to the duty ratio data; and
driving the plurality of light-emitting blocks according to the driving signal.

6. The method of claim 1, wherein the plurality of light-emitting blocks are driving at a maximum luminance during the initial period.

7. A light source apparatus comprising:
a light source module comprising a plurality of light-emitting blocks;
a driving signal generating part which drives the plurality of light-emitting blocks to a substantially uniform luminance during an initial period in response to a power-on signal; and
a local dimming control part which individually controls a luminance of the plurality of light-emitting blocks in accordance with respective luminances of a plurality of image blocks aligned with each of the plurality of light-emitting blocks after the initial period.

8. The light source apparatus of claim 7, wherein the substantially uniform luminance corresponds to a maximum luminance of the light-emitting blocks.

9. The light source apparatus of claim 7, wherein each of the plurality of light-emitting blocks comprises at least one lamp.

10. The light source apparatus of claim 9, wherein the driving signal generating part provides driving signals having a uniform duty ratio corresponding to the substantially uniform luminance to the plurality of light-emitting blocks during the initial period.

11. The light source apparatus of claim 9, wherein the local dimming control part comprises:
an image analysis part which obtains representative luminance data of respective light-emitting blocks of the plurality of light-emitting blocks using pixel data; and
a duty ratio determination part which determines duty ratio data of the plurality of light-emitting blocks using the representative luminance data,
wherein the driving signal generating part generates a driving signal of the plurality of light-emitting blocks based on the duty ratio data to provide the plurality of light-emitting blocks with the driving signal.

12. A display apparatus comprising:
a display panel;
a light source module comprising a plurality of light-emitting blocks;
a driving signal generating part which drives the plurality of light-emitting blocks to a substantially uniform luminance during an initial period in response to a power-on signal;
a local dimming control part which individually controls a luminance of each of the plurality of light-emitting blocks in accordance with respective luminances of a plurality of image blocks aligned with each of the plurality of light-emitting blocks after the initial period;
a compensation part which compensates pixel data of the plurality of image blocks in correspondence to the luminance of the plurality of light-emitting blocks; and
a panel driving part which drives the display panel.

13. The display apparatus of claim 12, wherein the substantially uniform luminance corresponds to a maximum luminance of the light-emitting blocks.

14. The display apparatus of claim 12, wherein each of the plurality of light-emitting blocks comprises at least one lamp.

15. The display apparatus of claim 14, wherein the driving signal generating part generates driving signals having a uniform duty ratio corresponding to the substantially uniform luminance to provide the plurality of light-emitting blocks with the driving signals during the initial period.

16. The display apparatus of claim 12, wherein the local dimming control part comprises:
an image analysis part which obtains representative luminance data of the respective light-emitting blocks using pixel data; and
a duty ratio determination part which determines duty ratio data of the plurality of light-emitting block using the representative luminance data,
wherein the driving signal generating part generates a driving signal of the plurality of light-emitting blocks based on the duty ratio data to provide the plurality of light-emitting blocks with the driving signal.

17. The display apparatus of claim 16, wherein the compensation part compensates the pixel data based on the duty ratio data.

18. The display apparatus of claim 12, wherein the panel driving part comprises:
a data driving part which converts the pixel data into an analog data signal and outputs the analog data signal to a data line of the display panel; and
a gate driving part which outputs a gate signal to a gate line of the display panel, the gate signal being synchronized with the analog data signal.

19. The display apparatus of claim 18, wherein the data driving part converts a primary pixel data into the analog data signal and outputs the analog data signal to the display panel.

20. The display apparatus of claim 18, wherein the data driving part converts a compensated pixel data into the analog data signal and outputs the analog data signal to the display panel.
